(19) United States
(12) Patent Application Publication
(10) Pub. No.: US 2005/0092189 A1
(43) Pub. Date: May 5, 2005

(54) Angel-food cake pan stand

(76) Inventor: Gerri Hall, Cecil Lake (CA)

Correspondence Address: ANTONY C. EDWARDS, SUITE 800 - 1708 DOLPHIN AVENUE, KELOWNA, BC, V1Y 9S4, CA

(21) Appl. No.: 10/972,481

(22) Filed: Oct. 26, 2004

Related U.S. Application Data
(60) Provisional application No. 60/516,842, filed on Nov. 4, 2003.

(51) Int. Cl. A47J 43/18

(52) U.S. Cl. 99/426

(57) ABSTRACT

A stand for mounting under an inverted angel-food cake pan having a central flume, wherein a distal end of the flume, distal from the base of the pan, has flume aperture. The stand includes a base plate having a base diameter which is substantially at least one half of the pan diameter. An elongate rod having opposite upper and lower ends is releasably mounted or mountable at the lower end to the base plate so as to extend orthogonally from the base plate, and so as to be substantially centrally disposed on the base plate. A conical insert having a wide end and an opposite tip end is mounted or releasably mountable at the wide end to the upper end of the rod so as to align the conical insert substantially coaxially with the rod and so as to dispose the tip end upwardly relative to the rod and the base plate.

### CROSS REFERENCE TO RELATED APPLICATION

This application claims priority from U.S. Provisional Patent Application No. 60/516,842 filed Nov. 4, 2003 entitled Angel-Food Cake Pan Stand.

### FIELD OF THE INVENTION

This invention relates to the field of kitchen or baking utensils and in particular to a stand for stably supporting an angel-food cake pan inverted over a base.

### BACKGROUND OF THE INVENTION

It is known in the prior art that it is advantageous to support inverted an angel food cake while it cools following baking so as to help prevent the cake falling or collapsing into a more dense mass of reduced volume in the pan in which it is contained. Conventionally angel food cake pans are toroidal, with a centrally disposed vertical flume, which may be cylindrical or conical, and a corresponding generally cylindrical wall defining a circular channel therebetween in which the cake is contained. When the cake pan is upright, that is, the channel opens upwardly, the vertical flume extends upwardly to the height of the walls of the channel.

Applicant has noted that conventionally the distal end, that is, the upper end of the vertical flume is open. This is presumably to facilitate the flow of hot air rising through the center of the cake, to thereby assist in uniform heating of the cake during baking. Applicant has also noted that the diameter of such openings varies, although within a generally predictable range. It is known in the prior art to invert such cake pans and suspend them in mid-air on ad-hoc stands such as soda-pop bottles or the like. It is left to the baker to match the particular diameter of the flume opening of the baker's particular angel-food pan with a corresponding diameter of the neck of a bottle so that the neck of the bottle may be inserted or journalled into the flume opening until the weight of the pan is supported wedged onto the neck of the bottle. The arrangement is quite unstable and, if it tips over, presents the risk of the glass bottle shattering.

A disadvantage to utilizing a bottle for this purpose is the necessity of finding and having available bottles of a size appropriate for each of the user's tube pans. In addition, bottles are fragile and generally have small bases and therefore afford limited stability. If the inverted cake and tube pan are not almost perfectly balanced on the bottle, the entire assembly will tip over. They are certainly easily knocked over.

### SUMMARY OF THE INVENTION

An angel food cake is a cake characterized by its light and airy texture. In order to achieve optimum consistency, the application of the specific mixing, baking and cooking techniques is required.

Angel food cakes are ordinarily baked in specialized pans herein referred to as tube pans, the common feature of which is that each such cake pan has a hollow, generally conical shaped tube or flume in the center of the tube pan. The dimensions of these tube pans, including the size of the opening of the center tube may vary. The tube pans are, on average, between nine and ten inches in diameter.

After mixing, the cake is baked in the tube pan, generally at a temperature of three hundred seventy five degrees Fahrenheit. A key element of the baking process is that immediately upon its removal from the oven, the hot tube pan, including the cake, should be inverted and allowed to cool. In order to achieve optimum cooling, it is preferable for the exposed surface of the now inverted cake to be above the work surface, of the kitchen counter. For example, the cake surface should be elevated three to six inches, to provide for ventilation.

The present invention is a tube pan stand which may be utilized for the inverted cooling of cakes baked in tube pans. The tube pan stand is in one embodiment comprised of three parts, namely, a rigid or slightly resilient cone, the base of which is mounted on a vertical, rigid rod or shaft which, in turn, is mounted perpendicularly to a rig rigid base.

The core comprised of a heat resistant material, such as heat resistant plastic or metal, for example coated aluminium, sufficient to withstand the when removed from the oven of the pan. In addition, the size and shape of the cone would be sufficient to accommodate a range of sizes in the openings in the distal end of the center flume of the tube pans

The three parts may be permanently affixed each to the other, or, alternatively, the three parts may be modular so that they may be assembled by threading or slip-fitting one part into another. This would provide the additional advantage of quick and easy disassembly for cleaning and space efficient storage.

In an embodiment wherein the cone is mounted on a rod or shaft, the rod or shaft is long enough to achieve the desired stand off distance, for example three to six inches, between the exposed surface of the inverted cake in the tube pan and the work surface while at the same time being sufficiently strong and rigid to support the weight of the cake and pan. The base on which the rod is mounted is of a diameter sufficient to provide stability to the assembly in the event that the cake and tube pan are inadvertently lightly bumped or jarred or are not perfectly balanced over or on the cake pan stand.

The inverted cake in its tube pan may be balanced on the cake pan stand by centering the opening of the cake pan tube or flume over the small end of the cone. If the inverted cake, in its tube pan, is not perfectly balanced over the cone and cake pan stand rod or shaft, the dimension of the cone and the frictional fit between the cone surface and the tube pan central flume opening will significantly reduce the likelihood of the pan slipping and tilting relative to the cone, which tilting might result in the entire assembly tipping over.

Thus the present invention is an angel-food tube pan stand for supporting an inverted angel-food tube pan wherein the pan includes a centrally disposed, hollow, truncated flume having an open base end and an opposite open distal end, where the open base end is mounted to the base of the pan so as to be symmetrically centered in the pan relative to the base of the flume. The stand includes at least a generally conically-shaped member have a wide base end and an opposite upper narrow tip. The conically-shaped member may be hollow or solid and may be adapted for mounting onto a wide supporting base. In one embodiment the generally conically-shaped member is a conical member or frusto-conical member mounted to an upper end of the elongate rigid member. The opposite lower end of the rigid member mounts or is mounted to the supporting base.

The tip of the conically-shaped member (hereinafter a conical member) is narrower than the wide base end and a conical or frusto-conical surface extends between the tip and the wide base end. The wide base end may, in one embodiment be mounted to the upper end of the elongate rigid member so that a longitudinal axis of symmetry of the conical member is substantially co-axial with a longitudinal axis of the elongate rigid member, whereby the tip is supported rigidly disposed above, and centrally located relative to, the base to support the pan when the pan is inverted and the tip is inserted into the open distal end of the flume.

What is not found in the prior art, and which it is an object of the present invention to provide, is an angel-food tube pan stand which may in one embodiment, be modularly dis-assembled for storage, and which, when assembled, elevates an upright conically-shaped member or insert above a base. The conical insert is sized to wedge into and mate with central openings of various diameters in the open ends of the pan flume, where the openings are within a range of diameters falling between the width of the upper tip of the conical insert and the width of the base of the conical insert.

In summary, the present invention is a stand for mounting under an inverted angel-food cake pan having a central flume, wherein a distal end of the flume, distal from the base of the pan, has flume aperture. In one embodiment the stand includes a base plate having a base diameter which is substantially at least one half of the pan diameter. An elongate rod having opposite upper and lower ends is releasably mounted or mountable at the lower end to the base plate so as to extend orthogonally from the base plate, and so as to be substantially centrally disposed on the base plate. A conical insert having a wide end and an opposite tip end is mounted or releasably mountable at the wide end to the upper end of the rod so as to align the conical insert substantially coaxially with the rod and so as to dispose the tip end upwardly relative to the rod and the base plate.

The tip end of the conical insert is sized so as to fit into the flume aperture of the cake pan. The conical insert is shaped so that the conical insert extends substantially at least one half of its length into the flume, that is, aperture before the diameter of the flume aperture becomes equivalent to a corresponding diameter of the conical insert where the flume aperture wedges in frictional engagement onto the conical insert.

The rod may have a diameter less than the wide end of the conical insert. The rod may be substantially at least three inches long so as to elevate a lowermost edge of the cake pan, when inverted and mounted onto the conical insert, at least three inches above the base plate. The base diameter may be at least three and one half inches. The conical insert may diverge from the tip end to the wide end at a substantially eight percent grade. The conical insert may be threadably mounted or mountable onto the rod, and the rod threadably mounted or mountable onto the base plate. The rod may be threadably mountable onto the base plate by means of a threaded fastener.

Alternatively, the stand may comprise a plurality, for example two, releasably interlocking pieces which, when interlocked, form a stand having a base section, an intermediate section rising from the base section, and an insert section rising from the intermediate section wherein the base is planar on a lower-most surface, and wherein the intermediate section may be formed of a first radially spaced apart array of substantially triangular members, and wherein the insert section may be formed of a second radially spaced apart array of substantially triangular members.

The first and second arrays of triangular members are radially spaced about a common vertical axis of symmetry. Each of the triangular members of the first array may be coplanar, for example formed as a unitary planar piece, with the corresponding triangular member in the second array.

In one preferred embodiment, first and second planar members, each including corresponding triangular members from the first and second arrays, vertically interlock by the mating of a pair of vertical slots, one in each planar member, orthogonally mating, a lower vertical slot in the first planar member slidably coupling down onto an upper vertical slot in the second planar member.

The first array may advantageously have outwardly sloping sides defining a first included angle with regards to the horizontal, for example the lower surface of the base. The second array may advantageously have outwardly sloping sides defining a second included angle with regards to the horizontal, wherein the second included angle is greater than the first included angle, whereby the insert section forms a sharper point, that is a more pointed upper end than the more outwardly flared intermediate section. This acts to restrain the pan from sliding too far down onto the stand.

### BRIEF DESCRIPTION OF THE DRAWINGS

FIGS. 1 and 2 are, in perspective view, two embodiments of the angel-food cake pan stand of the present invention onto which is mounted, partially cut away, an angel-food cake pan containing a cake.

FIG. 3 is, in perspective view, a further embodiment of the angel-food cake pan stand of the present invention.

FIG. 4 is a perspective view of an angel-food cake pan mounted on the stand of FIG. 3.

FIG. 5 is in perspective view, a further alternative embodiment of the present invention.

FIG. 6 is the stand of FIG. 5 in exploded view.

FIGS. 7a and 7b are the stand components of FIG. 6, each in front elevation view.

### DETAILED DESCRIPTION OF EMBODIMENTS OF THE INVENTION

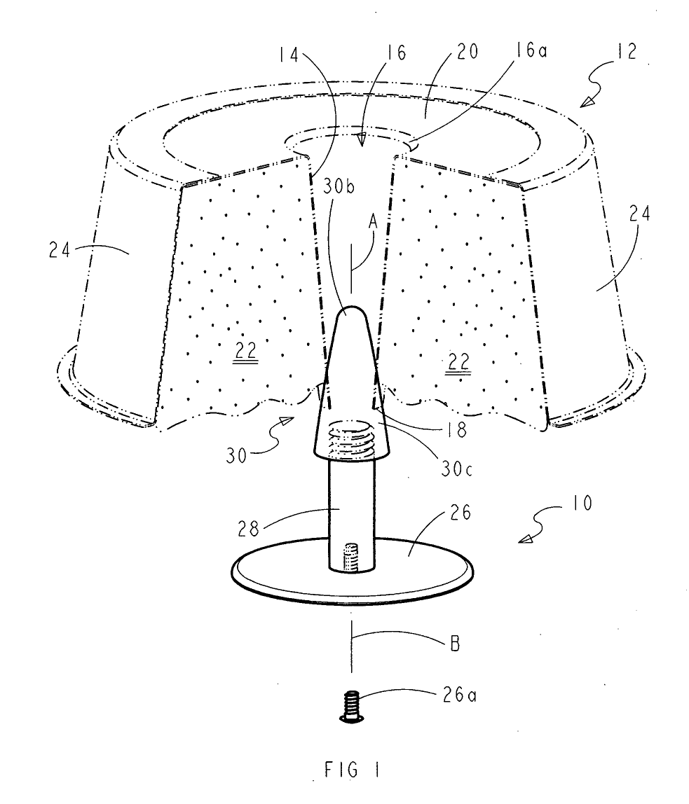

As illustrated by way of example in FIG. 1, cake pan stand 10 is adapted for supporting an inverted cake pan such as an angel-food cake pan 12. Pan 12 is conventional and includes a centrally disposed, hollow, truncated conical flume 14. Flume 14 has an open base end 16 and an opposite open distal end 18. The open base end 16 is mounted circumferentially around its rim 16a to the base 20 of the pan so as to be symmetrically centered in the pan relative to the base of the cone. Following baking of a cake mix placed into the annular trough of pan 12, the trough contains a light cake 22, such as an angel-food cake. The trough is defined as the toroidal cavity between flume 14, base 20, and generally cylindrical wall 24.

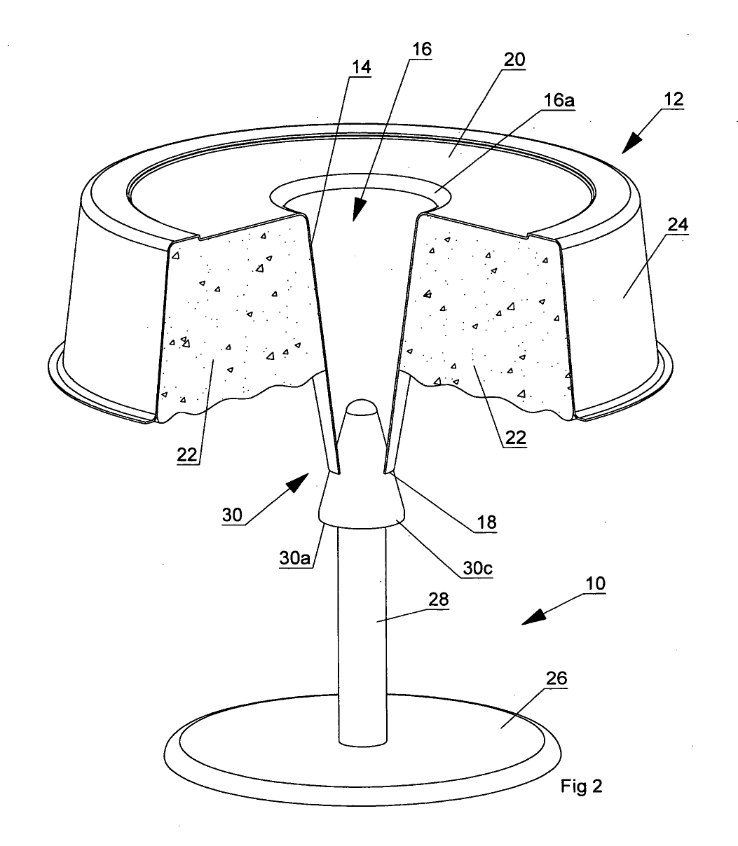

In the examples of FIGS. 1 and 2, stand 10 includes a rigid base 26 which may, without intending to be limiting, be a disc or platen as depicted. An elongate rigid member such as a pole, shaft or rod 28 is mounted, for example by means of threading into the base or by, for example, screw 26a, at a lower end thereof to base 26. A conical or frusto-conical member or insert 30 is mounted on the upper end of rod 28, for example by means of an adhesive or a threaded mating of insert 30 onto the upper end of rod 28.

Conical insert 30 has a wide end 30a and an opposite tip 30b. Tip 30b is narrower than wide end 30a. A conical or frusto-conical surface 30c extends between tip 30b and wide end 30a. Wide end 30a is mounted to the upper end of rod 28 so that a longitudinal axis of symmetry A of conical insert 30 is substantially co-axial with a longitudinal axis B of the rod 28. Tip 30b is thus supported rigidly disposed above base 26 so as to support pan 12 when tip 30b is inserted, in frictionally mating engagement into the open distal end 18 of flume 14. In one embodiment, the cone-shape flares at approximately an eight percent grade. Base 26 has a diameter which is relatively large compared to the diameter of the pair, advantageously substantially fifty percent or greater. Thus, for a seven inch pan the base would have a diameter of at least or approximately three and one half inches and rod 28 would be at least or approximately three inches long.

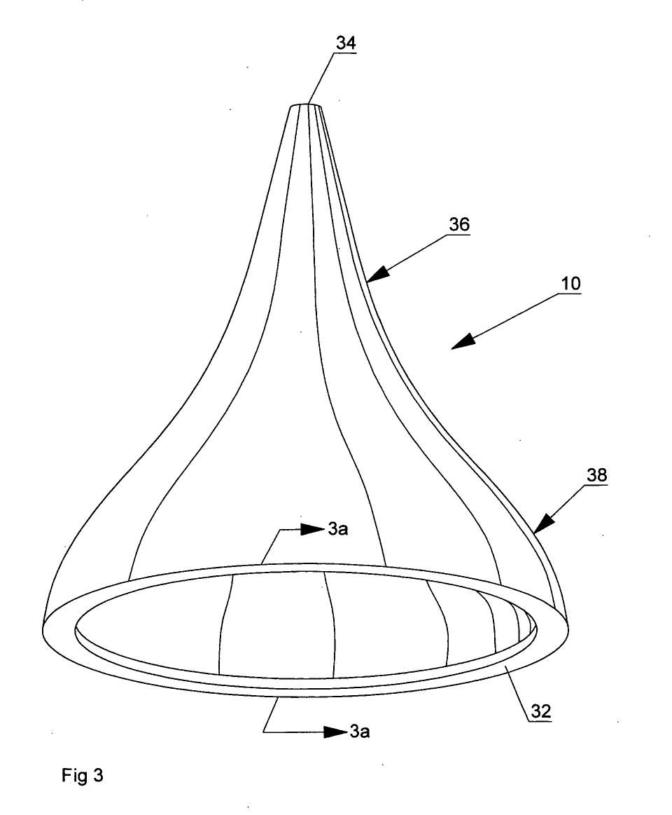

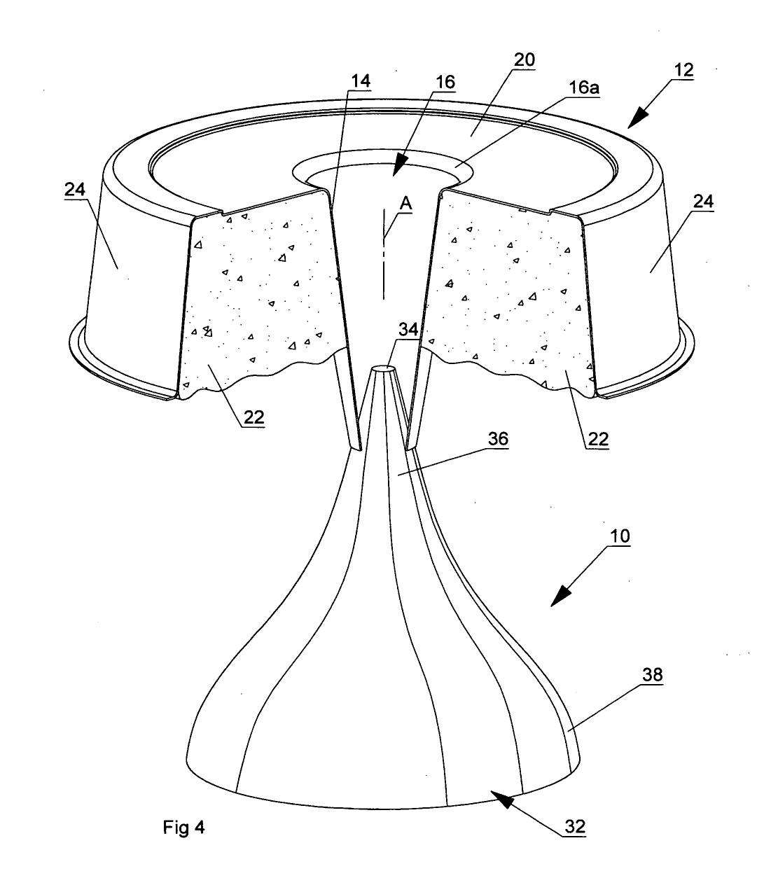

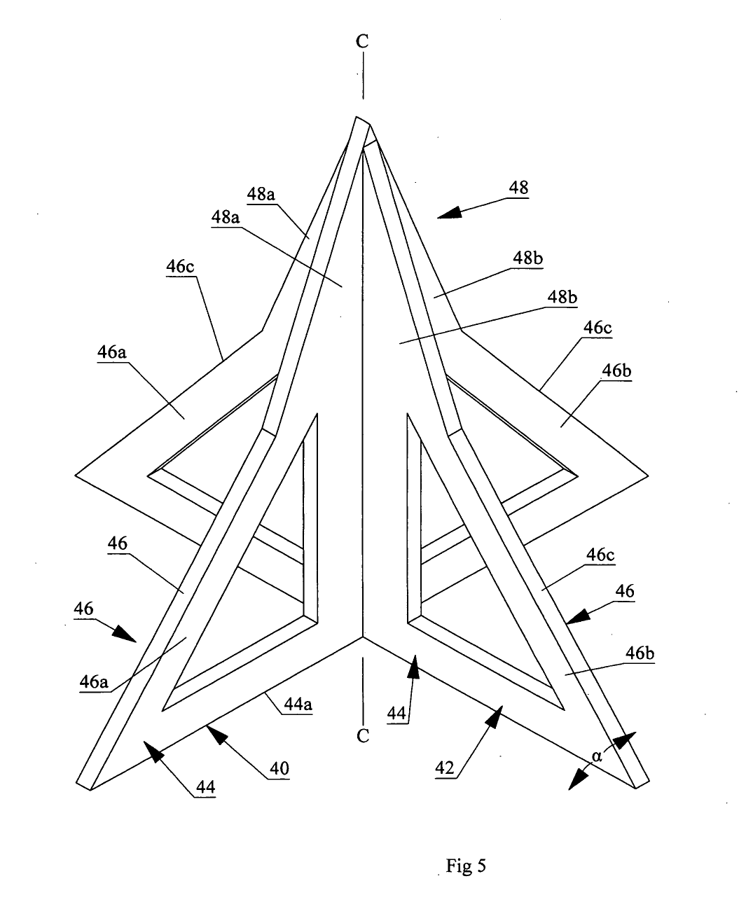

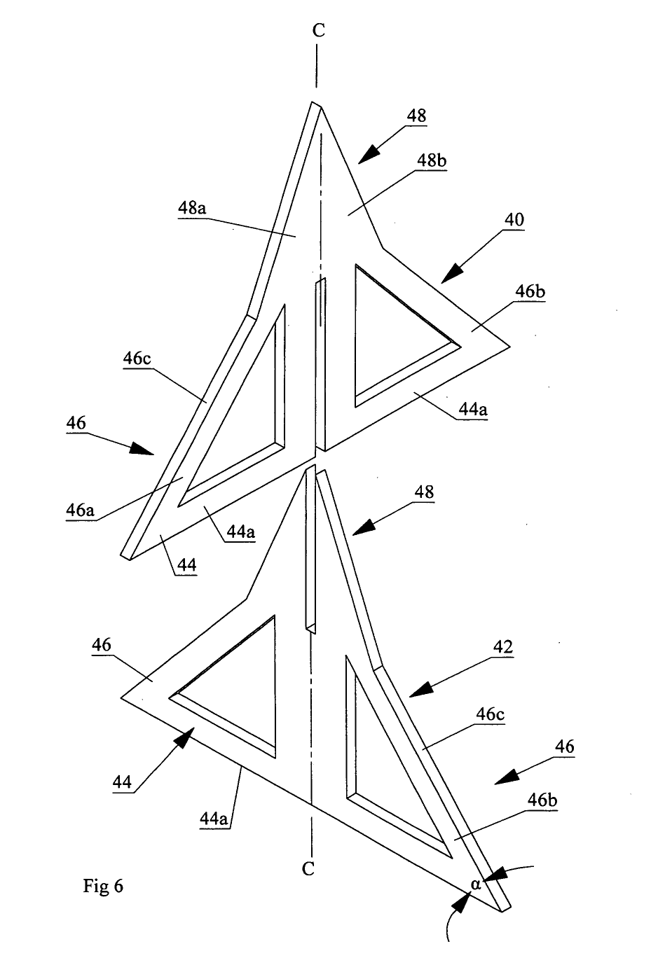

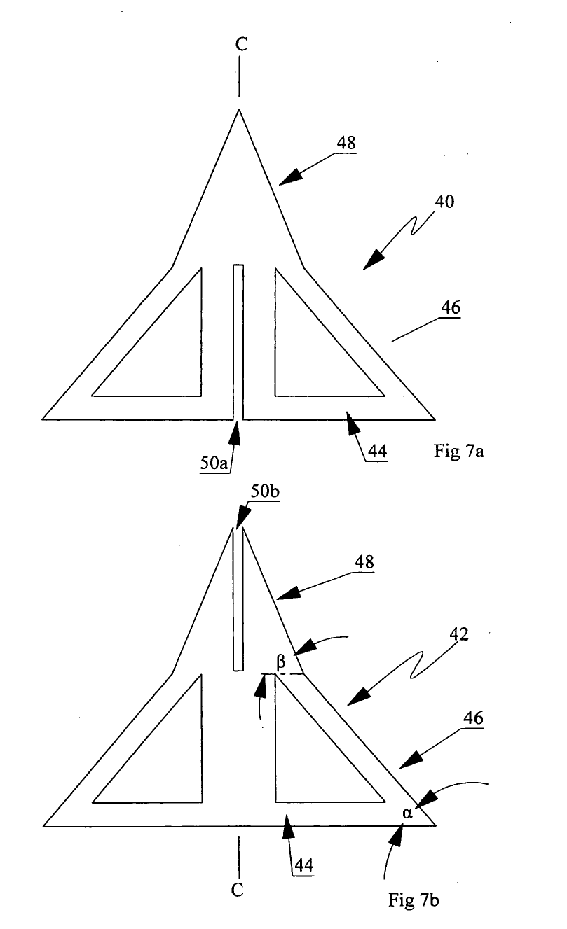

In the alternative embodiment of FIGS. 3 and 4, stand 10 is formed as a rigid funnel. In the illustrated embodiment, not intended to be limiting, the funnel is hollow, having a lower base rim 32, for placing on a rigid work surface, and an opposite narrow end 34. As seen in FIG. 3a, aperture 34a may be formed in narrow end 34 to allow expanding warm air to escape. The narrow end has an elongate narrow portion 36 which flares downwardly curvaceously into a squat base end portion 38 above base rim 32. Elongate narrow portion 36 functions as does conical insert 30 in the embodiment of FIGS. 1 and 2 so as to insert into the flume 14, and base end portion 38 functions as does base 26 in FIGS. 1 and 2 to stably support the cake and tube pan when mounted onto the narrow portion 36. A draw-back of this embodiment is that it is not modular as in the embodiment of FIGS. 1 and 2 and so may not be as compactly stored. Further, the conical insert may not be inter-changed with conical inserts of different sizes to accommodate different flumes, or at least flumes having different hole sizes.

Alternatively, the stand may be formed of releasably interlocking first and second planer members 40, 42 which, when interlocked, form a stand having a base section 44, an intermediate section 46 rising from the base section, and an insert section 48 rising from the intermediate section. Base section 44 is planar on its lower-most surface 44a. Intermediate section 46 is formed of a first radially spaced apart array of substantially triangular members 46a and 46b. Insert section 48 is formed of a second radially spaced apart array of substantially triangular members 48a and 48b on either side of vertical axis of symmetry C. The first and second arrays of triangular members are radially spaced about a common vertical axis of symmetry C. Each of the triangular members of the first array may, as illustrated, be coplanar, for example formed as a unitary planar piece, with the corresponding triangular member in the second array.

First and second planar members 40, 42 each include corresponding triangular members from the first and second arrays. Member 40 and 42 vertically interlock by the mating of a pair of vertical slots 50a and 50b, one in each planar member. The slots mate orthogonally. The lower vertical slot 50a in the first planar member 40 slidably snugly couples down onto the upper vertical slot 50b in the second planer member 42 until lower surfaces 44a are co-planar.

The first array that is the array corresponding to the intermediate section, may advantageously have outwardly sloping sides defining a first included angle with regards to the horizontal, for example the lower surface of the base. The second array may advantageously have outwardly sloping sides defining a second included angle β with respect to the horizontal. Second included angle β is greater than first included angle α, whereby the insert section forms a sharper point, that is a more pointed upper end than the more outwardly flared intermediate section. This acts to restrain the pan 24 and in particular flume 18 from sliding too far down onto the stand.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

1. For mounting under an inverted angel-food cake pan having a central flume, wherein a distal end of the flume, distal from the base of the pan, has flume aperture, and wherein the pan has a pan diameter, an angel-food cake pan stand comprising:
a base plate having a base diameter which is substantially at least one half of the pan diameter,
an elongate rod having opposite upper and lower ends and releasably mountable at said lower end to said base plate so as to extend orthogonally therefrom and so as to be substantially centrally disposed on said base plate,
a conical insert having a wide end and an opposite tip end and said wide end releasably mountable to said upper end of said rod so as to align said conical insert substantially coaxially with said rod and so as to dispose said tip end upwardly relative to said rod and said base plate,
wherein said tip end is sized so as to fit into the flume aperture of the cake pan, and wherein said conical insert is shaped so that said conical insert extends substantially at least one half of its length into said flume aperture before the diameter of said flume aperture becomes equivalent to a corresponding diameter of said conical insert where said flume aperture wedges in frictional engagement onto said conical insert.

2. The stand of claim 1 wherein said rod is of a diameter less than said wide end of said conical insert.

3. The stand of claim 1 wherein said rod is substantially at least three inches long so as to elevate a lowermost edge of the pan, when inverted and mounted onto said conical insert, at least three inches above said base plate.

4. The stand of claim 3 wherein said base diameter is at least three and one half inches.

5. The stand of claim 1 wherein said conical insert diverges from said tip end to said wide end at a substantially eight percent grade.

6. The stand of claim 1 wherein said conical insert is threadably mountable onto said rod, and said rod is threadably mountable onto said base plate.

7. The stand of claim 6 wherein said rod is threadably mountable onto said base plate by means of a threaded fastener.

8. For mounting under an inverted angel-food cake pan having a central flume, wherein a distal end of the flume, distal from the base of the pan, has flume aperture, and wherein the pan has a pan diameter, an angel-food cake pan stand comprising:
a base plate having a base diameter which is substantially at least one half of the pan diameter,
an elongate rod having opposite upper and lower ends and mounted at said lower end to said base plate so as to extend orthogonally therefrom and so as to be substantially centrally disposed on said base plate,
a conical insert having a wide end and an opposite tip end and said wide end mounted to said upper end of said rod so as to align said conical insert substantially coaxially with said rod and so as to dispose said tip end upwardly relative to said rod and said base plate,
wherein said tip end is sized so as to fit into the flume aperture of the cake pan, and wherein said conical insert is shaped so that said conical insert extends substantially at least one half of its length into said flume aperture before the diameter of said flume aperture becomes equivalent to a corresponding diameter of said conical insert where said flume aperture wedges in frictional engagement onto said conical insert.

9. The stand of claim 8 wherein said rod is of a diameter less than said wide end of said conical insert.

10. The stand of claim 8 wherein said rod is substantially at least three inches long so as to elevate a lowermost edge of the pan, when inverted and mounted onto said conical insert, at least three inches above said base plate.

11. The stand of claim 10 wherein said base diameter is at least three and one half inches.

12. The stand of claim 8 wherein said conical insert diverges from said tip end to said wide end at a substantially eight percent grade.

13. The stand of claim 8 wherein said conical insert is threadably mounted onto said rod, and said rod is threadably mounted onto said base plate.

14. The stand of claim 13 wherein said rod is threadably mounted onto said base plate by means of a threaded fastener.

15. An angel food cake pan stand comprising a plurality of releasably interlocking members which, when interlocked, form a stand having a base section, an intermediate section rising from said base section, and an insert section rising from said intermediate section wherein said base section is planar on a lower-most surface of said base section, and wherein said intermediate section is formed of a first radially spaced apart array of substantially triangular members, and wherein said insert section is formed of a second radially spaced apart array of substantially triangular members,
wherein said first and second arrays of triangular members are radially spaced about a common vertical axis of symmetry, and wherein said first array is a lower array having outwardly sloping sides defining a first included angle with respect to the horizontal, and wherein said second array is an upper array having outwardly sloping sides defining a second included angle with respect to the horizontal, and wherein said second included angle is greater than said first included angle, whereby the insert section forms a pointed upper end which is more pointed than the more radially outwardly flared intermediate section so as to act to restrain the cake pan from sliding too far down onto the stand.

16. The stand of claim 15 wherein each of said triangular members of said first array are coplanar.

17. The stand of claim 16 wherein said triangular members are formed as a unitary planar piece, with a corresponding triangular member in said second array.

18. The stand of claim 17 wherein each said unitary planar piece vertically interlock by the mating of a pair of vertical slots, one in each said unitary planar piece, orthogonally mating, a lower vertical slot in a first piece of said unitary planar pieces so as to slidably couple down onto an upper vertical slot in a second piece of said unitary planar pieces.
